(19) United States
(12) Patent Application Publication
(10) Pub. No.: US 2005/0147301 A1
(43) Pub. Date: Jul. 7, 2005

(54) System and method for collaborative handwriting input

(76) Inventors: Jingtao Wang, Beijing (CN); Hui Su, Beijing (CN); Arimasa Naitoh, Raleigh, NC (US); Atsushi Kumaki, Kanagawa (JP)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(21) Appl. No.: 10/486,262

(22) PCT Filed: Jul. 23, 2002
(86) PCT No.: PCT/US02/23574

(30) Foreign Application Priority Data
Aug. 8, 2001 (CN) 01 1 24787.8

(51) Int. Cl. G06K 9/00

(52) U.S. Cl. 382/187

(57) ABSTRACT

A system and method for collaborative handwriting input. An input hand-held computer captures, stores and redisplays ink information from a user and transfers the ink information to a recognition computer via a communication connection, which then recognizes it and outputs recognition result. A method is also employed in such a system for collaborative handwriting input. And in an embodiment, the system can comprise a recognition computer and a plurality of input hand-held computers.

### FIELD OF THE INVENTION

The present invention relates generally to handwriting input of a computer, and in particular to a system and method for the collaborative handwriting input between two computers.

### BACKGROUND OF THE INVENTION

Handwriting input has become a popular input method. The method is especially important for the Asian countries where the properties of their characters bring inconvenience during the text entry task by traditional keyboard.

Up to now, significant progress has been made with handwriting recognition technology, and recognition accuracy has been increased significantly. For example, the U.S. Pat. No. 5,751,851 titled Method of Splitting Handwriting Input, filed in Jul. 17, 1996, and patented in May 12, 1998, invented by Kenneth J. Guzik and John L. C. Seybold, disclosed a method for splitting and machine recognition of handwriting input strokes, and is herein incorporated by reference in its entirety.

A common handwriting input device consists of handwriting tablet, electric stylus and connection cable and is generally connected to the computer via peripherals such as serial port, USB etc. The input strokes and recognized character can be echoed on the computer screen at the time of handwriting input. However, the above method usually has the following limitations: First, no visual feedback on the handwriting tablet due to the separation of inputting and displaying; Second, difficulty in hand-eye collaboration especially on error correction; Third, inconvenience for carrying the handwriting tablet as well as related cable, this problem is especially serious for mobile laptop users.

However, pen-based hand-held computers are widely used, examples of such computers are personal digital assistant (PDA) (e.g. IBM Workpad®) and smart mobile phone with pen-based interfaces, etc. All of these computers generally employ pen input and redisplay the corresponding input strokes by combining the touch sensitive panel and other types of input tablet with the display screen. The U.S. Pat. No. 5,347,477 titled Pen-based Form Computer, filed in Mar. 2, 1993, patented in Sep. 13, 1994, and invented by Jack Lee, disclosed a computer with such type, and is herein incorporated by reference in its entirety. Such computers are small in size, convenient to carry and institutive for input, however, in view of the limited computing power and storage capacity of such hand-held computer, or the processing ability and storage capacity of the processor falls far behind that of the desktop computer or laptop computer, complete and effective handwriting recognition could hardly be obtained.

Meanwhile, users of laptop computer need an input solution that is highly portable and can be easily and effectively operated. Accordingly, there raised such a requirement of collaborative handwriting input using the hand-held computer as an input device for laptop or desktop computer. Since the hand-held computer is intuitive in displaying handwriting scripts and is convenient for carrying, while the laptop or desktop computer has powerful processing power, the combination can make the most use of each role.

### SUMMARY OF THE INVENTION

The object of the invention is to solve the above problems by providing device, system and method for collaborative handwriting input between two or more computer of different types, without physically modifying the existing computers of the user. At the time of collaborative handwriting input, a connection is established between the two computers, and the collection and recognition of the input strokes are completed on different computers.

The present invention provides a system for collaborative handwriting input. The system comprises an input computer (e.g. a PDA or a smart phone) acting as the digitizing tablet and a recognition computer. The said hand-held computer comprises: first protocol abstraction layer means for establishing communication connection for handwriting input based on the standard communication protocols; ink capture means for collecting and storing ink information written by a user; ink display means for displaying the captured ink information; ink information transferring means for transmitting the captured ink information to a recognition computer via said first protocol abstraction layer means. The said recognition computer comprises: second protocol abstraction layer means for establishing communication connection for handwriting input based on the standard communication protocols; ink information receiving means for receiving the ink information from said input hand-held computer; handwriting recognizer for recognizing the received ink information; result output means for outputting the recognition results.

The present invention also provides a method for carrying out collaborative handwriting input in an information processing system. The method comprises the following steps: establishing a communication connection between the recognition computer and the input computer (e.g. a hand-held PDA); capturing, storing and displaying ink information from a user on the input hand-held computer; transferring captured ink information to the recognition computer; recognizing the ink information on the recognition computer; and outputting recognition result.

### BRIEF DESCRIPTION OF THE DRAWINGS

FIG. 1 is a schematic graph illustrating the system for collaborative handwriting input according to one embodiment of the invention;

FIG. 2 is a schematic block diagram illustrating computer 10 for handwriting input recognition according to one embodiment of the invention;

FIG. 3 is a schematic block diagram illustrating the hand-held computer 20 for handwriting input according to one embodiment of the invention;

FIG. 4 is a flow chart illustrating the method for carrying out collaborative handwriting input recognition according to one embodiment of the invention;

FIG. 5 is a flow chart illustrating the method for carrying out collaborative handwriting input recognition according to another embodiment of the invention;

FIG. 6 is a flow chart illustrating the method for carrying out collaborative handwriting input recognition according to another embodiment of the invention;

FIG. 7 is a schematic graph illustrating how do a plurality of hand-held computers 20 complete the handwriting input recognition in collaboration with one handwriting recognition computer according to one embodiment of the invention;

### DESCRIPTION OF THE INVENTION

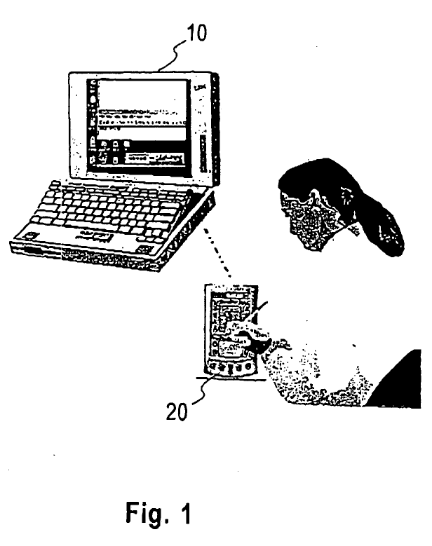

FIG. 1 is a schematic graph illustrating the system for collaborative handwriting input according to one embodiment of the invention. Handwriting input is completed collaboratively by the pen input hand-held computer 20 and laptop computer 10. The said hand-held computer 20 is used for collecting and displaying ink information and selecting the candidate characters, while the said laptop computer 10 is used for handwriting recognition. Data are exchanged between the hand-held computer 20 and laptop computer 10 via specific physical communication connections (e.g. infrared or USB).

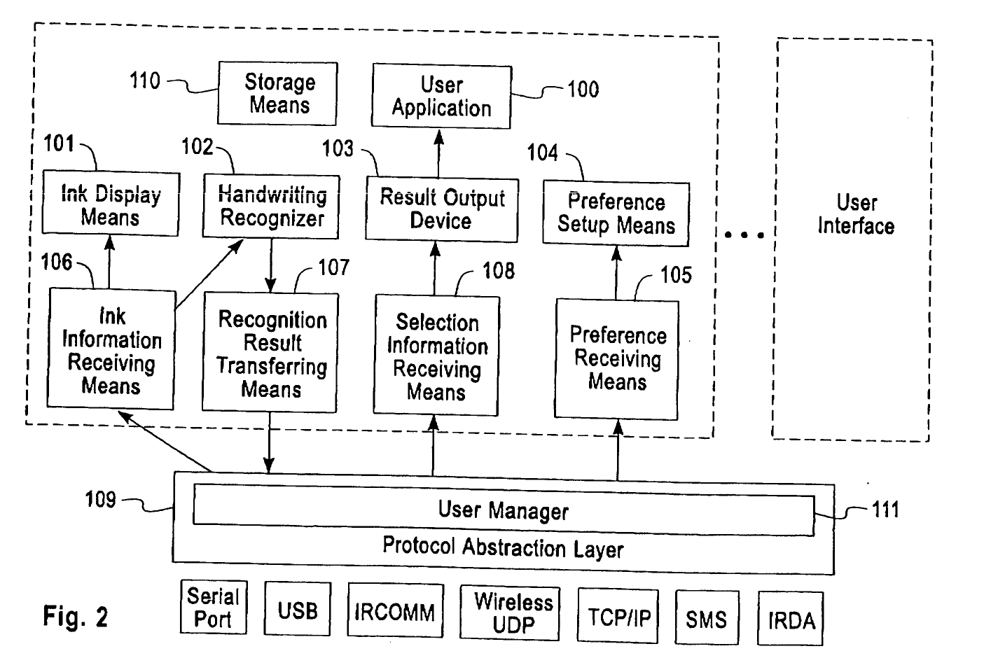

FIG. 2 is a schematic block diagram illustrating computer 10 for handwriting input recognition according to one embodiment of the invention. The recognition computer 10 may be a common PC, a laptop computer or any other computers which may have more powerful computing capability and storage capacity than that of the hand-held computer 20 in order to bring into full use of the potential of the core of the handwriting recognition. The computer 10, which may be a desktop computer, a laptop computer, a server or a top setting box etc, should have the indispensable components (not illustrated in the drawings) of CPU, bus, memory, permanent storage device (i.e. hard disk, floppy disk or compact disk etc.), display adapter, display and keyboard, and have one or more of the following communication port such as serial port, parallel port, USB, IRCOMM, wireless UDP or network interface card etc.

As shown in FIG. 2, a user application 100 is running on the recognition computer 10 to which the user wants to input characters. The application may be any one like Word Processor, Spreadsheet program, Email program or even software development applications. The protocol abstraction layer 109 is designed to establish communication link between the computer 10 and the hand-held computer 20 corresponding to the protocol abstraction layer 209 in the hand-held computer. There are numerous known communication protocols and devices used for computer, for example, serial port, USB, IRCOMM, wireless UDP, types of network interface cards, SMS and IRDA etc. The protocol abstraction layer 109 establishes a communication link for handwriting input recognition based on the above standard communication protocol. The protocol abstraction layer 109 is an protocol abstraction layer that abstracts and encapsulates the standard communication protocol, masks the difference between the physical protocols and provides a unified service interface for the upper layer. The remaining components of the present invention only need an interface with the protocol abstraction layer 109 without having to know the specific underlying communication protocol. This increases the scalability of the invention and allows for addition of support for the new specific communication protocol on the protocol abstraction layer.

The recognition computer 10 further includes an ink information receiving means 106 for receiving the ink information from the hand-held computer 20 via the said protocol abstraction layer and transferring the ink information to the handwriting recognizer 102. The handwriting recognizer 102 may be a handwriting recognition engine based on any handwriting recognition arithmetic, such as the handwriting recognition method proposed by the U.S. Pat. No. 5,751,851 or other handwriting recognition engines, for example, IBM® Japanese Handwriting Recognition Engine. After recognizing the ink information, the handwriting recognizer 102 transfers the recognition results to the recognition result transferring means 107. The recognition result is a group of candidate characters and similarity parameters, or a group of candidate characters in sequence of similarity (or probability), which is transferred to the hand-held computer 20 by the recognition result transferring means 107 via the communication protocol means 109.

The selection information receiving means 108 in FIG. 2 is designed to receive the selection information selected by the user from the candidates, and to transfer the selected information to the output means 103. Output means 103 then inputs the recognized character selected by the user to user application 100.

As further illustrated in FIG. 2, the recognition computer 10 also consists of ink display means 101 connected to the ink information receiving means 106 and is used for displaying the received ink information at an appropriate position on the screen of the computer for the user to compare. Storage means 110 is used for the other components of the invention to store the temporary information. The preference receiving means 105 is designed to receive the user preferences from the hand-held computer 20 via the protocol abstraction layer 109 and transmitting the user preferences to the preference setup means 104. Preference setup means 104 may receive the user preference information from itself or from the preference receiving means 105, and control the operation of other components of the invention according to the preference information such as, the preference of the handwriting recognizer 102 (language, character set and favorite on accuracy or speed), the preference of the ink display means 101 (thickness and color of the strokes), preference of the protocol abstraction layer 109 (specific transferring protocol, rate and the way of checking etc.), and other preference settings such as time delay of recognition. User manager 111 which is connected to the protocol abstraction layer 109 is used for verify the User Identification (ID), initiates a corresponding user instance for different user.

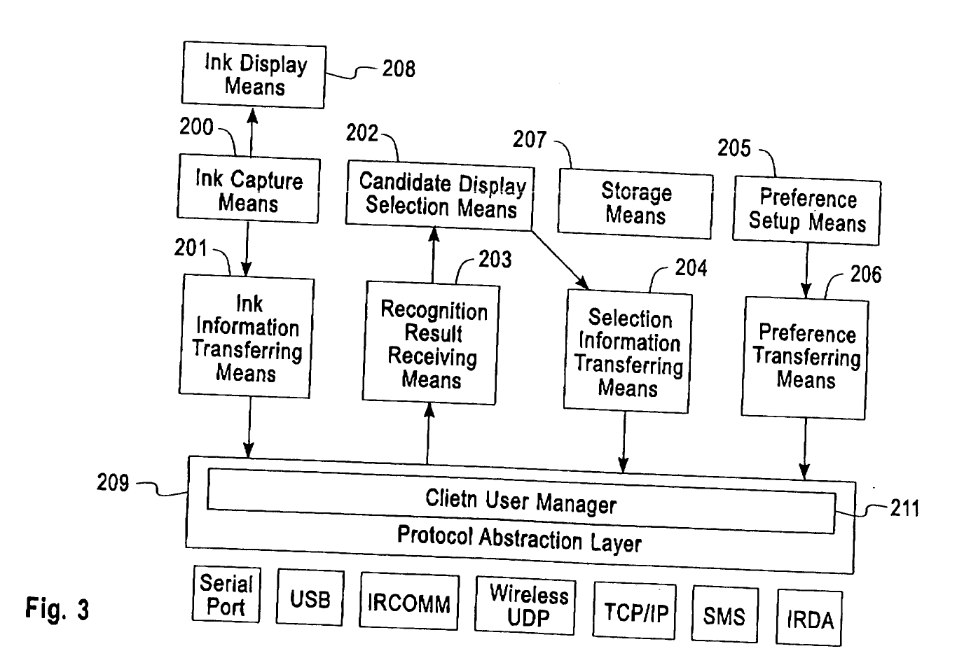

FIG. 3 is a schematic block diagram illustrating the hand-held computer 20 for handwriting input according to one embodiment of the invention. The hand-held computer may be pen input computer such as HPC (for example, WordPad of IBM), personal data assistant (PDA), and the mobile phone with computing functions. The hand-held computer should be equipped with processor, storage memory, display (LCD for example), touch sensitive panel or other types of input tablet and electric stylus etc, among which, the display and the input tablet can be integrated into one body which is generally called touch screen or input screen. A variety of communication ports are widely used in the current hand-held computer, for example, serial port, parallel port, USB port, IRCOMM, wireless UDP or network interface card etc. In the present invention, the hand-held computer 20 for handwriting input includes one or more of the above communication ports.

As illustrated in FIG. 3, the protocol abstraction layer 209 is designed to establish communication link between the hand-held computer 20 and the recognition computer 10 corresponding to the protocol abstraction layer in the recognition computer 10. In corresponding to the protocol abstraction layer 109 in the recognition computer 10 described above, the protocol abstraction layer 209 establishes the communication link to the recognition computer 10 for handwriting input recognition on the basis of various communication protocols such as serial port, USB, IRCOMM, wireless UDP, all kinds of network interface cards, SMS and IRDA.

In FIG. 3, the ink capture means 200 is designed to record the pen operation activities including pen movements, pen up/pen down information on the input tablet, i.e., ink information, in certain way and store the information in a proper database. The information can be recorded in the form of raster or vector image, both of which are widely used in the prior art. The ink information recorded in the form of vector can be converted into the form of raster. The ink display device 208 redisplays the ink information captured by the ink capture means 200 to the user. Ink information transferring means 201 transfers the ink information captured by the ink capture means 200 to the above mentioned ink information receiving means 106 in the recognition computer 10 via the protocol abstraction layer 209.

Recognition result receiving device 203 receives the recognition result from recognition result transferring means 107 in the recognition computer 10 via the protocol abstraction layer 209, and transmits the recognition result to candidate display/selection means 202. The candidate display/selection means 202 displays the recognized characters and candidate characters on the screen for the user to select, and accepts the selection for the candidates by the user and transmit the selection information to selection information transferring means 204. The selection information transferring means 204 transfers the selection of the user to selection information receiving means 108 in the recognition computer 10.

The hand-held computer 20 illustrated in FIG. 3 further includes preference setup means 205 for setting up the preference of the collaborative input applications of the hand-held computer 20 of the present invention and identifying the preference of the computer 10. For the preference information on the recognition computer 10 side, the preference setup means 205 can transmit them to the preference transferring means 206. Preference transferring means 206 transfers the preference at the recognition computer 10 end to the preference receiving means 105 in the recognition computer 10 via the protocol abstraction layer 209. The client user manager 211 which is connected with the protocol abstraction layer 209, is designed to maintain a unique user ID that identifies the hand-held computer and transmits the user ID to the recognition computer.

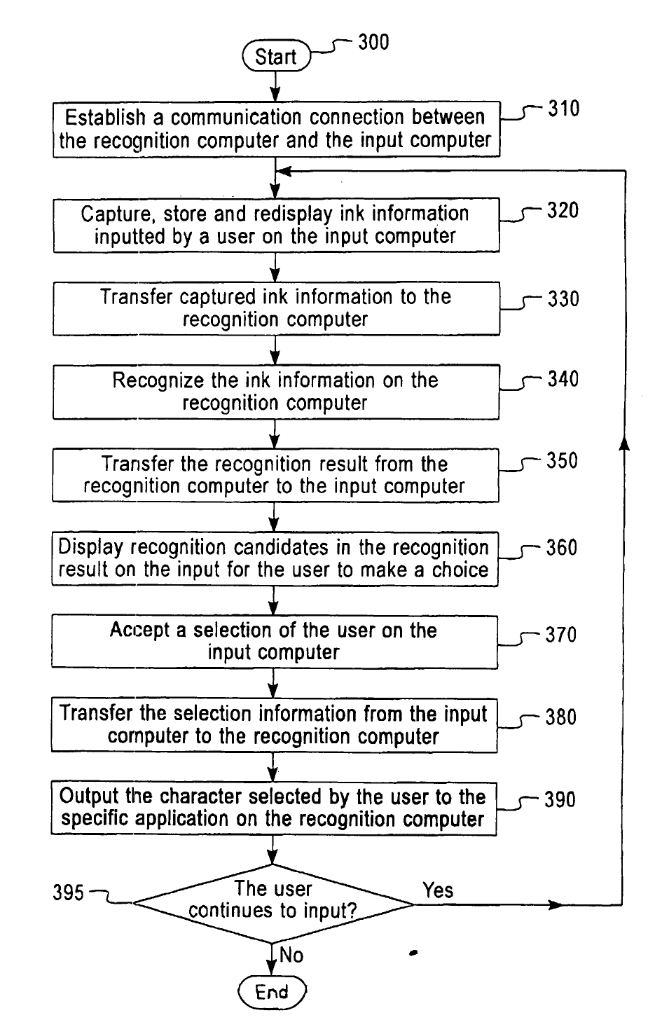

FIG. 4 is a flow chart illustrating the method for carrying out collaborative handwriting input recognition according to one embodiment of the invention. As illustrated in the figure, it begins at step 300. In step 310, a communication link is established via the said protocol abstraction layer 109 in the recognition computer 10 and said protocol abstraction layer 209 in input hand-held computer. The computer 10 and the hand-held computer 20 also initiate themselves and acknowledge each other in this step. In step 320, ink information input by the user is captured, stored and redisplayed on the input computer. The ink information may take various forms such as raster form or vector form, etc. The ink information in form of vector is widely used at present, for the form can not only record the shape of the ink, but also the order of strokes which is also quite important in handwriting recognition. In the present invention, the captured ink information may take either the raster form or the vector form.

In step 330, the ink information captured on the input computer 20 is transferred to the recognition computer 10 via the communication link established in step 310. In step 340, the ink information transferred to the recognition computer is recognized therein by the handwriting recognizer 102 of the recognition computer 102. The recognition result is a group of candidate characters and similarity (possibility) parameters, or a group of candidate characters in sequence of similarity. In step 350, the recognition result is transmitted from the recognition computer 10 to the input computer 20.

Then in step 360, other candidate characters in the recognition result is displayed on the input computer, allowing a user to make selection; In step 370, selection made by the user is accepted. Then in step 380, the selection information of the user is transmitted from the input computer 20 to the recognition computer 10. In step 390, the characters selected by the user are outputted to the designated application on the recognition computer. In step 395, it determines whether to continue the handwriting input, if YES, it returns to step 320 to continue inputting the next character, otherwise, it goes to the end step 400.

According to one embodiment of the invention, after transferring the captured ink information from the input computer 20 to the recognition computer 10, the ink information can be restored to ink image and be displayed.

According to anther embodiment of the invention, ink capturing and transferring of the ink information is carried out synchronously. Thus with the redisplayed ink on the recognition computer according to previous embodiment, synchronous display of handwriting input on the input computer 20 and the recognition computer 10 will be achieved.

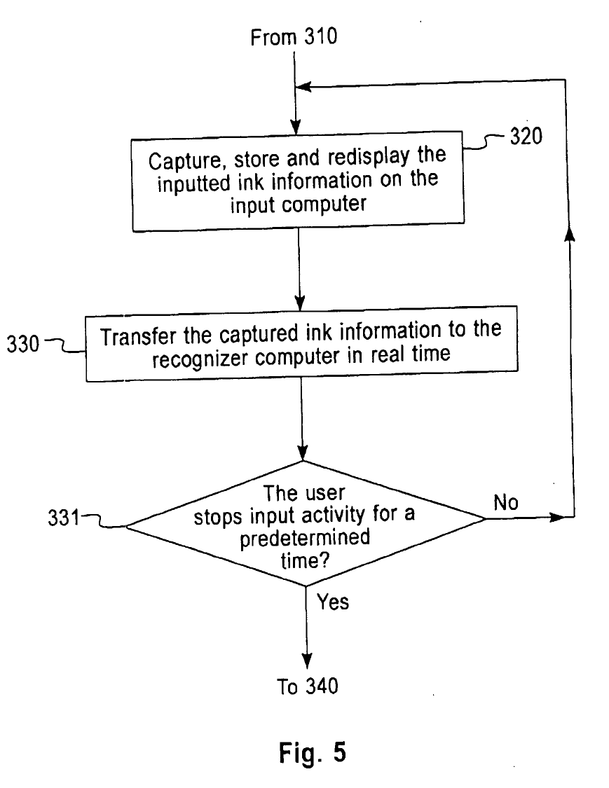

According to another embodiment, as shown in FIG. 5, following step 310, in step 320, ink information from a user is captured, stored and redisplayed on the input computer, in step 330, the captured ink information is transferred to the recognition computer 10 in real time, but computer 10 does not perform recognition on the transferred ink information in return. If the user in this process stops the action of stroke over a predetermined time, for example, 0.5 second, then handwriting recognizer 20 is activated to make recognition.

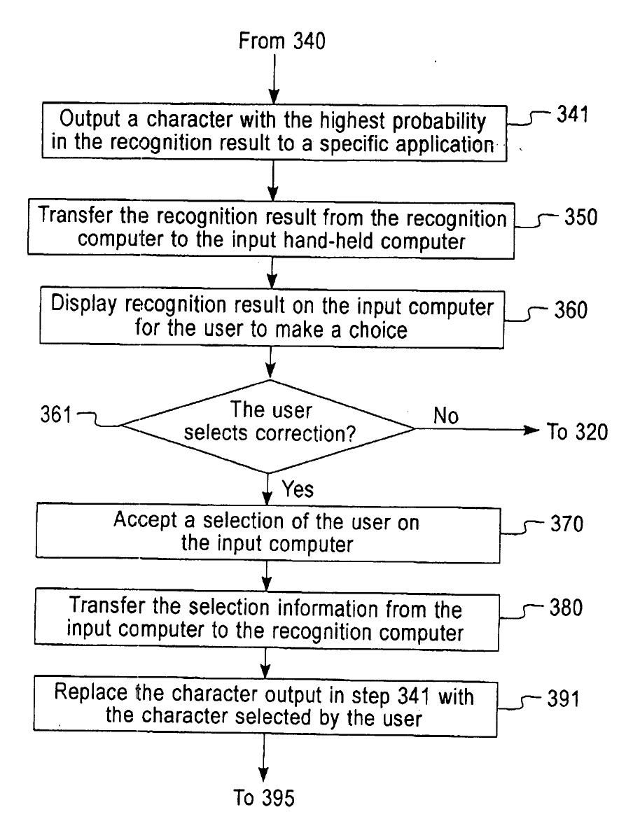

According to another embodiment of the invention, as shown in FIG. 6, in step 340, the transferred ink information is recognized on the recognition computer. In step 341, the character with the greatest similarity in the recognition result is outputted to the designated application. The highest similarity herein refers to the character being of the highest probability to the user's desire as seen from the handwriting recognizer 102. Then, in step 350, recognition result is transferred from the recognition computer 10 to the input computer 20; In step 360, the other candidate characters in the recognition result are displayed on the input computer 20 for the user's choice. In this case, the user may either select another candidate character or go on with the next input. If the user continues to input, it returns to step 320 again. If the user selects another candidate character, the selection of the user is accepted in step 370; and in step 380, the selection information of the user is transferred from the input computer 20 to the recognition computer 10. Then in step 391, the character outputted in step 341 is replaced with the selected character of the user on the recognition computer, then it goes to step 395. In this way, for the characters correctly recognized by handwriting recognizer, the user may simply keep on inputting and does not need to make selections or determinations.

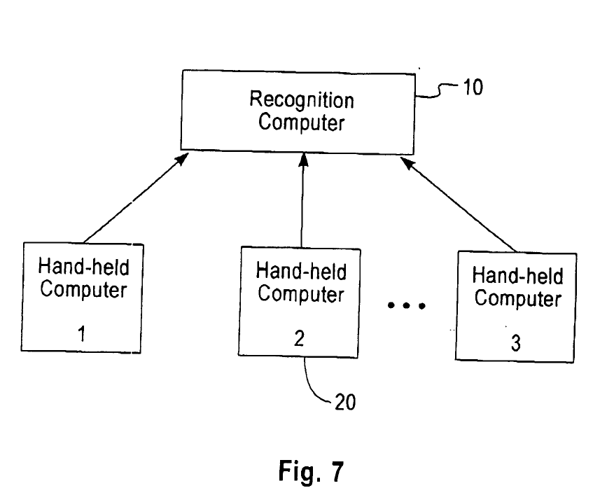

According to another embodiment of the invention, the collaborative handwriting input system of the invention can be constructed such that one recognition computer 10 is connected with a plurality of input computers, as shown in FIG. 7, and the connections to each input computer may be established via different protocols, this can be better understood in combination with the above description of the protocol abstraction layer 109 and 209 used in the present invention. In this embodiment, the recognition computer 10 is connected with a plurality of hand-held computers 20 for collaborative handwriting input. In this embodiment, the protocol abstraction layer 109 in the recognition computer has a user manager 111 on its top; and the protocol abstraction layer 209 in the input computer 20 also has a client user manger 211.

During the establishment of the connection, the client user manager 211 in the input computer 20 firstly sends a user ID of the computer to the recognition computer 10, the user manager 111 in the recognition computer then receives and verifies the user ID. IF the user ID is verified, the user manager 111 initiates a user instance corresponding to input computer. As shown in FIG. 2, an user instance includes all the components in respect to the user's recognition computer 10 except the user manager 111 and the protocol abstraction layer 109. The user manager 111 interacts with each component in the user instance.

In addition, one embodiment of the present invention also includes the steps of setting up the user preference regarding the input computer 20 and the recognition computer 10 on the input computer 20; and transmitting the preference information from the input computer 20 to the recognition computer 10. Therefore, the user may customize his or her favorite way of inputting through input computer.

While the present invention has been described using several specific embodiments, it is obvious to those skilled in the art that, various changes and modifications could be made without departing from the spirit and scope of the invention. Hence, the above embodiments are merely illustrative and intended to be limiting. The true scope of the invention is only indicated by the following claims.

1. A system for collaborative handwriting input, comprising:
an input hand-held computer, comprising:
first protocol abstraction layer means for establishing communication connection for handwriting input based on standard communication protocols;
ink capture means for collecting and storing ink information from a user;
first ink display means for display the captured ink information;
ink information transferring means for transmitting the captured ink information to a recognition computer via said first protocol abstraction layer means; and
the recognition computer comprising:
second protocol abstraction layer means for establishing communication connection for handwriting input based on standard communication protocols;
ink information receiving means for receiving the ink information form said input hand-held computer;
handwriting recognizer for recognizing the received ink information to generate a recognition result including recognition candidates;
result output means for outputting the recognition results.

2. The system of claim 1, wherein said input hand-held computer further comprising:
recognition result receiving means for receiving the recognition result from said recognition computer;
candidate display/selection means for displaying the recognition candidates in the received recognition result and accepting a selection for the candidates by the user;
selection information transferring means for transmitting the selection information of the user to said recognition computer via said first protocol abstraction layer means; and
wherein said recognition computer further comprising:
recognition result transferring means for transmitting the recognition result to said input hand-held computer via said second protocol abstraction layer means;
selection information receiving means for receiving the selection information from said input hand-held computer via said second protocol abstraction layer means.

3. The system of claim 2, wherein said recognition computer further comprising second ink display means for redisplaying the received ink information.

4. The system of claim 2, wherein said input hand-held computer further comprising:
first preference setup means for setting user preferences of handwriting input;
preference transferring means for transmitting the user preferences to said recognition computer via first protocol abstraction layer means; and
wherein said recognition computer further comprising:
second preference setup means for setting user preferences of handwriting input;
preference receiving means for receiving the user preferences from said input hand-held computer via second protocol abstraction layer means.

5. The system of claim 2, wherein said input hand-held computer further comprising a client user manager for maintaining a unique user ID that identifies said input hand-held computer and transmitting the user ID to said recognition computer via said first protocol abstraction layer means; and
said recognition computer further comprising a user manager for verifying the user ID received from said input hand-held computer and initiating a corresponding user instance.

6. The system of claim 5, wherein the system comprising a recognition computer and a plurality of input hand-held computers.

7. A method for collaborative handwriting input in a information processing system including a recognition computer and an input hand-held computer, comprising:
establishing a communication connection between the recognition computer and the input hand-held computer;
capturing, storing and display ink information from a user on the input hand-held computer;
transferring captured ink information to the recognition computer;
recognizing the ink information on the recognition computer; and
outputting recognition result.

8. The method of claim 7, wherein said recognizing step further comprising:
transferring the recognition result form the recognition computer to the input hand-held computer;
displaying recognition candidates in the recognition result on the input hand-held computer;
accepting a selection of the user for the candidates; and
transferring the selection information of the user from the input hand-held computer to the recognition computer.

9. The method of claim 7, wherein said capturing step and said transferring step are synchronous, and further comprising the step of determining whether the user stop input activity for a predetermined time.

10. The method of claim 7, wherein said step of transferring ink information further comprising the step of redisplay the input ink on the recognition computer.

11. The method of claim 7, wherein said recognizing step further comprising:
outputting a character with the highest probability in the recognition result to a specific application;
transferring the recognition result from the recognition computer to the input hand-held computer;
displaying recognition candidates in the recognition result on the input hand-held computer;
determining whether the user selects correction, if not, return to capturing step;
accepting a selection for the candidates by the user;
transferring the selection information from the input hand-held computer to the recognition computer; and
replacing the character output to the specific application with the character selected by the user.

12. The method of claim 7, wherein said establishing step comprising:
sending a user ID from the input hand-held computer to the recognition computer;
verifying the user ID on the recognition computer;
initiating a corresponding user instance for each user ID on the recognition computer; and
establishing a communication connection between the recognition computer and the input hand-held computer.

13. The method of claim 12, wherein said information processing system comprising a recognition computer and a plurality of input hand-held computers.
